(19) United States
(12) Patent Application Publication
(10) Pub. No.: US 2011/0134399 A1
(43) Pub. Date: Jun. 9, 2011

(54) Lithographic Projection Apparatus

(75) Inventors: Johannes Wilhelmus Damen, Budel (NL); Anko Jozef Cornelus Sijben, Veghel (NL); Johannes Albert Rozenveld, Maarheeze (NL); Jeroen-Frank Dekkers, 's-Hertogenbosch (NL); Eugene Maria Brinkhof, Weert (NL); Hermannus Antonius Langeler, Eindhoven (NL); Petrus Albertus Johannes Francisca Van Gompel, Hapert (NL)

(73) Assignee: ASML Netherlands B.V., Veldhoven (NL)

(21) Appl. No.: 12/813,930

(22) Filed: Jun. 11, 2010

Related U.S. Application Data
(60) Provisional application No. 61/218,184, filed on Jun. 18, 2009.

(51) Int. Cl. G03B 27/52; H01R 13/40

(52) U.S. Cl. 355/30; 439/586

(57) ABSTRACT

A lithographic apparatus arranged to transfer a pattern onto a substrate is disclosed. The lithographic apparatus comprises a power supply and an electrical connector. The electrical connector electrically connects the power supply to another component of the lithographic apparatus. The electrical connector comprises a laminate that comprises, in order, a first conducting layer, a first flexible insulating layer, a conductor configured to carry an electrical current, a second flexible insulating layer and a second conducting layer.

### CROSS REFERENCE TO RELATED APPLICATIONS

This application claims benefit under 35 U.S.C. §119(e) to U.S. Provisional Patent Application No. 61/218,184, filed Jun. 18, 2009, which is incorporated by reference herein in its entirety.

### BACKGROUND

1. Field of the Invention

Embodiments of the present invention relate to a lithographic apparatus.

2. Background Art

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g., including part of, one, or several dies) on a substrate (e.g., a silicon wafer). Transfer of the pattern is typically via imaging onto a layer of radiation-sensitive material (resist) provided on the substrate. In general, a single substrate will contain a network of adjacent target portions that are successively patterned. Known lithographic apparatus include so-called steppers, in which each target portion is irradiated by exposing an entire pattern onto the target portion at one time, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from a patterning device to the substrate by imprinting the pattern onto the substrate.

Some moving parts of the lithography apparatus are powered by a high voltage power supply. Furthermore, for some lithographic processes, parts of the lithography apparatus are kept at very low pressure. In particular, at very low pressure, a high voltage power supply may be used to power any actuators, blades or clamps that may be part of the lithography apparatus. Actuators are used to position the table on which the substrate is placed. Actuators also power blades that block a portion of the projection beam. Clamps hold the mask or the substrate to a table. One example of a clamp is an electrostatic clamp, which includes electrodes that are connected to a power supply.

Due to the fact that high voltage is used, and in particular because the components are situated in a very low-pressure environment, there is a problem that electrical breakdown may occur. The possibility of electrical breakdown limits the voltage of the power lines and presents a safety hazard. If a breakdown occurs, it can damage optical surfaces, create electromagnetic interference that disturbs sensitive electronics and present a human safety hazard. Electrical discharge may cause deterioration of any insulation material of an electrical power line. This may reduce the lifetime of the electrical power line. Electrical discharge may give rise to unwanted effects such as electromagnetic interference. Such electromagnetic interference may have a negative influence on electronic circuits and/or may violate legislation of industry standards.

### SUMMARY

An electrical connector is provided that is suitable for making a high voltage electrical connection at low pressure in which electrical breakdown is reduced or eliminated. In an embodiment, an electrical connection is provided for use between a high voltage power supply and a component of a lithographic apparatus.

According to an aspect of the present invention, there is provided a lithographic apparatus arranged to transfer a pattern from a patterning device onto a substrate. The lithographic apparatus includes a power supply and an electrical connector. The electrical connector electrically connects the power supply to another component of the lithographic apparatus. The electrical connector includes a laminate that includes, in order, a first conducting layer, a first flexible insulating layer, a conductor configured to carry an electrical current, a second flexible insulating layer and a second conducting layer.

According to a further aspect of the present invention, there is provided an apparatus including a vacuum chamber, a vacuum evacuator, a power supply and an electrical connector. The vacuum evacuator is configured to reduce the pressure within the vacuum chamber to less than or equal to 100 Pa. The electrical connector includes a laminate that includes, in order, a first conducting layer, a first flexible insulating layer, a conductor configured to carry an electrical current, a second flexible insulating layer and a second conducting layer. The electrical connector electrically connects the power supply to another component of the apparatus. The electrical connector and the component of the apparatus to which the electrical connector connects the power supply are inside the vacuum chamber.

According to a further aspect of the present invention, there is provided an electrical connector for connecting a component of a lithographic apparatus to a power supply. The electrical connector includes a laminate that includes, in order, a first conducting layer, a first flexible insulating layer, a conductor configured to carry an electrical current, a second flexible insulating layer and a second conducting layer.

### BRIEF DESCRIPTION OF THE DRAWINGS

Embodiments of different aspects of the present invention will now be described, by way of example only, with reference to the accompanying schematic drawings, in which corresponding reference symbols indicate corresponding parts, wherein:

FIG. 1 depicts a lithographic apparatus according to an embodiment of the invention;

FIG. 2 depicts a schematic view of two flexible planar electrical connectors according to an embodiment of the invention;

FIG. 3 depicts a schematic view of a flexible planar electrical connector according to one embodiment of the invention;

FIG. 4 depicts a schematic view of a flexible planar electrical connector according to one embodiment of the invention;

FIG. 5 depicts a beam interceptor connected to a power supply according to an embodiment of the invention;

FIG. 6 depicts an electrostatic clamp connected to a power supply according to an embodiment of the invention;

FIG. 7 depicts an electrostatic clamp connected to a flexible planar electrical connector according to an embodiment of the invention;

FIG. 8 depicts the theoretical Paschen curve for parallel plates in air;

FIG. 9 depicts a schematic cross sectional view of the flexible planar electrical connector according to an embodiment of the invention;

FIG. 10 depicts a schematic view of the flexible planar electrical connectors connected to each other according to an embodiment of the invention;

FIG. 11 depicts a schematic view of the flexible planar electrical connectors connected to each other according to an embodiment of the invention.

### DETAILED DESCRIPTION

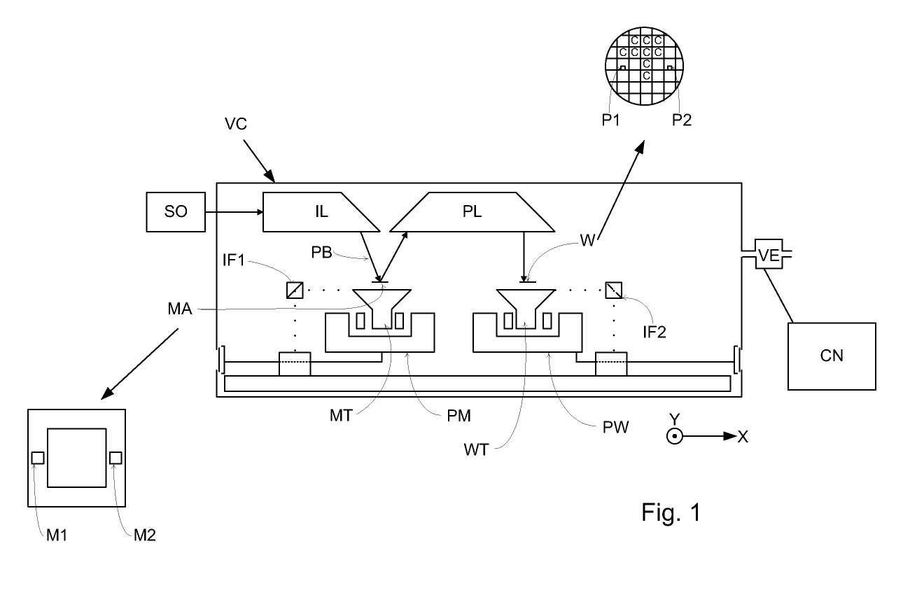

FIG. 1 schematically depicts a lithographic apparatus according to one embodiment of the invention. The apparatus includes:

an illumination system (illuminator) IL configured to condition a radiation beam B (e.g., UV radiation or EUV radiation).

a support structure (e.g., a mask table) MT constructed to support a patterning device (e.g., a mask) MA and connected to a first positioner PM configured to accurately position the patterning device in accordance with certain parameters;

a substrate table (e.g., a wafer table) WT constructed to hold a substrate (e.g., a resist-coated wafer) W and connected to a second positioner PW configured to accurately position the substrate in accordance with certain parameters; and

a projection system (e.g., a refractive projection lens system) PS configured to project a pattern imparted to radiation beam B by patterning device MA onto a target portion C (e.g., including one or more dies) of substrate W.

The illumination system may include various types of optical components, such as refractive, reflective, magnetic, electromagnetic, electrostatic or other types of optical components, or any combination thereof, for directing, shaping, or controlling radiation.

The support structure supports, i.e., bears the weight of, the patterning device. It holds the patterning device in a manner that depends on the orientation of the patterning device, the design of the lithographic apparatus, and other conditions, such as for example whether or not the patterning device is held in a vacuum environment. The support structure can use mechanical, electrostatic or other clamping techniques to hold the patterning device. The support structure may be a frame or a table, for example, which may be fixed or movable as required. The support structure may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam, which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a reflective type (e.g., employing a reflective mask). Alternatively, the apparatus may be of a transmissive type (e.g., employing a transmissive mask).

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

The lithographic apparatus may also be of a type wherein at least a portion of the substrate may be covered by a liquid having a relatively high refractive index, e.g., water, so as to fill a space between the projection system and the substrate. An immersion liquid may also be applied to other spaces in the lithographic apparatus, for example, between the mask and the projection system. Immersion techniques are well known in the art for increasing the numerical aperture of projection systems. The term “immersion” as used herein does not mean that a structure, such as a substrate, must be submerged in liquid, but rather only means that liquid is located between the projection system and the substrate during exposure.

Referring to FIG. 1, illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from source SO to illuminator IL with the aid of a beam delivery system BD including, for example, suitable directing mirrors and/or a beam expander. In other cases the source may be an integral part of the lithographic apparatus, for example when the source is a mercury lamp. Source SO and illuminator IL, together with beam delivery system BD if required, may be referred to as a radiation system.

Illuminator IL may include an adjuster AD for adjusting the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, illuminator IL may include various other components, such as an integrator IN and a condenser CO. The illuminator may be used to condition the radiation beam, to have a desired uniformity and intensity distribution in its cross-section.

A masking device, which defines the area on the patterning means that is illuminated, may be included in illuminator IL. The masking device may include a plurality of blades, for example four, whose positions are controllable, e.g., by actuators such as stepper motors, so that the cross-section of the beam may be defined. It should be noted that the masking device need not be positioned proximate the patterning means but in general will be located in a plane that is imaged onto the patterning means (a conjugate plane of the patterning means). The open area of the masking means defines the area on the patterning means that is illuminated but may not be exactly the same as that area, e.g., if the intervening optics have a magnification different than 1.

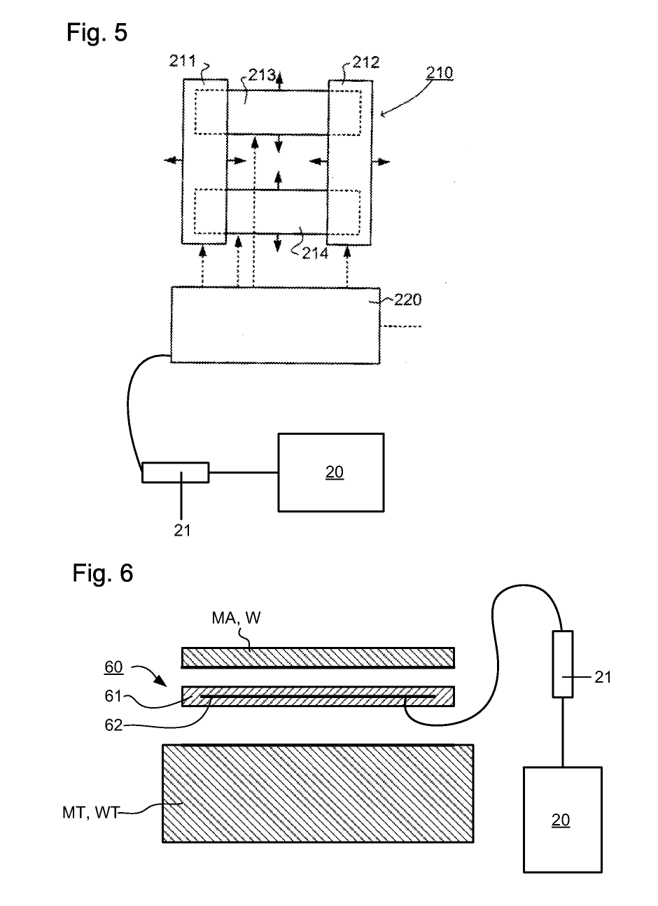

According to an embodiment of the invention, the masking device includes a beam interceptor 210, including opaque blades 211, 212, 213, 214 that are arranged to intercept part of radiation beam B, as is shown in FIG. 5. Blades 211, 212, 213, 214 manipulate the size and shape of the exposed projection beam B on mask MA and accordingly on target portions C. The movement and positioning of blades 211, 212, 213, 214 is controlled by a control system 220. If a projected target portion C is not fully positioned on substrate W, control system 220 is arranged to define a new size for this particular target portion C and actuate beam interceptor 210 accordingly.

The patterning device (e.g., mask MA) is held on the support structure (e.g., mask table MT) and is patterned by the patterning device. Mask MA can be clamped to mask table MT on both surfaces of the mask. By clamping mask MA on both surfaces, the mask can be subjected to large accelerations without slipping or deformation. The clamping, or holding force may be applied using thin membranes, which further prevent deformation of the mask. By the clamp, a normal force between adjacent surfaces of the mask and mask table MT is generated, resulting in a friction between contacting surfaces of the mask and the mask table. The clamping force to the surfaces of mask MA may be generated using electrostatic or mechanical clamping techniques.

In EUV lithographic processes, electrostatic clamps may be used to clamp mask MA to mask table MT and/or substrate W to substrate table WT. FIG. 6 depicts an exemplary electrostatic clamp that is connected to a power supply 20 via an electrical connection system 21 according to an embodiment of the present invention. In the exemplary electrostatic clamp depicted in FIG. 6, a chuck 60 includes a dielectric or slightly conductive body 61 with an embedded electrode 62. Power supply 20 is used to apply a potential difference between mask MA or substrate W and chuck 60 and between chuck 60 and table MT, WT so that electrostatic forces clamp mask MA or substrate W and chuck 60 to the table MT, WT. Embedded electrode 62 is connected to power supply 20.

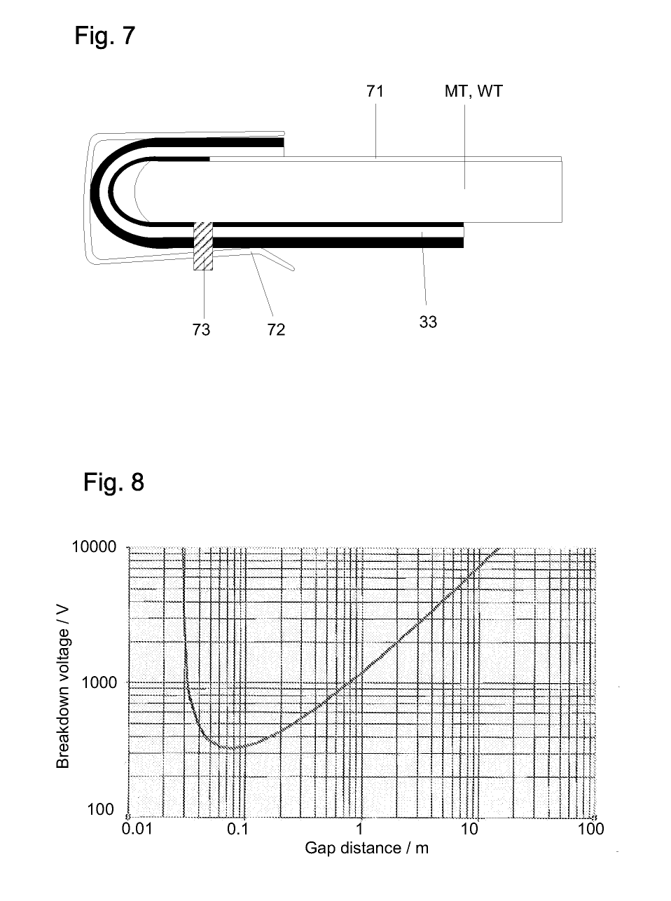

FIG. 7 schematically depicts how a flexible planar electrical connector 25 that includes part of an electrical connection system 21 according to an embodiment of the invention may be connected to an electrode 71 of a mask table MT or a substrate table WT. A conductor 33 of flexible electrical connector 25 contacts electrode 71. Flexible connector 25 is held to electrode 71 by a clip 72. The clip is flexible and provides a force pressing connector 25 to the table. This provides a secure electrical connection between flexible connector 25 and electrode 71.

Optionally, electrical connector 25 is held to electrode 71 by a combination of a clip 72 and a pin 73. Pin 73 is connected to clip 72 and extends through a hole in electrical connector 25 to contact the table on which electrode 71 is formed.

Radiation beam B is incident on the patterning device (e.g., mask MA). Having traversed mask MA, radiation beam B passes through projection system PS, which focuses the beam onto a target portion C of substrate W. With the aid of the second positioner PW and position sensor IF2 (e.g., an interferometric device, linear encoder or capacitive sensor), substrate table WT can be moved accurately, e.g., so as to position different target portions C in the path of radiation beam B. Similarly, first positioner PM and another position sensor IF1 can be used to accurately position mask MA with respect to the path of radiation beam B, e.g., after mechanical retrieval from a mask library, or during a scan. In general, movement of mask table MT may be realized with the aid of a long-stroke module (coarse positioning) and a short-stroke module (fine positioning), which form part of first positioner PM. Similarly, movement of substrate table WT may be realized using a long-stroke module and a short-stroke module, which form part of second positioner PW. In the case of a stepper (as opposed to a scanner) mask table MT may be connected to a short-stroke actuator only, or may be fixed. Mask MA and substrate W may be aligned using mask alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on mask MA, the mask alignment marks may be located between the dies.

The depicted apparatus could be used in at least one of the following modes:

1. In step mode, mask table MT and substrate table WT are kept essentially stationary, while an entire pattern imparted to the radiation beam is projected onto a target portion C at one time (i.e., a single static exposure). Substrate table WT is then shifted in the X and/or Y direction so that a different target portion C can be exposed. In step mode, the maximum size of the exposure field limits the size of the target portion C imaged in a single static exposure.

2. In scan mode, mask table MT and substrate table WT are scanned synchronously while a pattern imparted to the radiation beam is projected onto a target portion C (i.e., a single dynamic exposure). The velocity and direction of substrate table WT relative to mask table MT may be determined by the (de-)magnification and image reversal characteristics of projection system PS. In scan mode, the maximum size of the exposure field limits the width (in the non-scanning direction) of the target portion in a single dynamic exposure, whereas the length of the scanning motion determines the height (in the scanning direction) of the target portion.

3. In another mode, mask table MT is kept essentially stationary holding a programmable patterning device, and substrate table WT is moved or scanned while a pattern imparted to the radiation beam is projected onto a target portion C. In this mode, generally a pulsed radiation source is employed and the programmable patterning device is updated as required after each movement of substrate table WT or in between successive radiation pulses during a scan. This mode of operation can be readily applied to maskless lithography that utilizes programmable patterning device, such as a programmable mirror array of a type as referred to above.

In a lithographic projection apparatus according to the present invention, at least one of first object table MT (support structure for supporting the patterning means, the mask) and second object table WT (the substrate table) are provided in a vacuum chamber VC. The vacuum inside vacuum chamber VC is created with evacuating means VE, for example a pump.

Combinations and/or variations on the above described modes of use or entirely different modes of use may also be employed.

First positioner PM, second positioner PW, the motors that control any blades that may be included in the masking device, and any clamps that may be included in the lithographic projection apparatus are powered by a high voltage power supply. In particular, the electrodes of an electrostatic clamp used for clamping a substrate W to a substrate table WT or a mask M to a mask table MT in near-vacuum conditions are connected to a bi-polar high voltage supply.

High voltage is taken to mean that the power supply produces an output of the order of hundreds or thousands of volts. In an embodiment, the output of the power supply is greater than 0.1 kV, greater than 0.2 kV, greater than 0.5 kV, greater than 1 kV, greater than 2 kV, greater than 5 kV, or greater than 10 kV. Optionally, the power supply provides an output voltage of up to 20 kV. Some lithographic manufacturing methods are required to be performed at very low pressure, such as 100 Pa, 50 Pa, 10 Pa or 5 Pa. For example, lithographic methods that use EUV radiation must be performed at very low pressure. This is because air absorbs the EUV radiation. Each component of the lithographic apparatus must therefore be suitable for use at low pressure. This includes the electrical connectors that connect one or more components of the lithographic apparatus to high voltage power supplies.

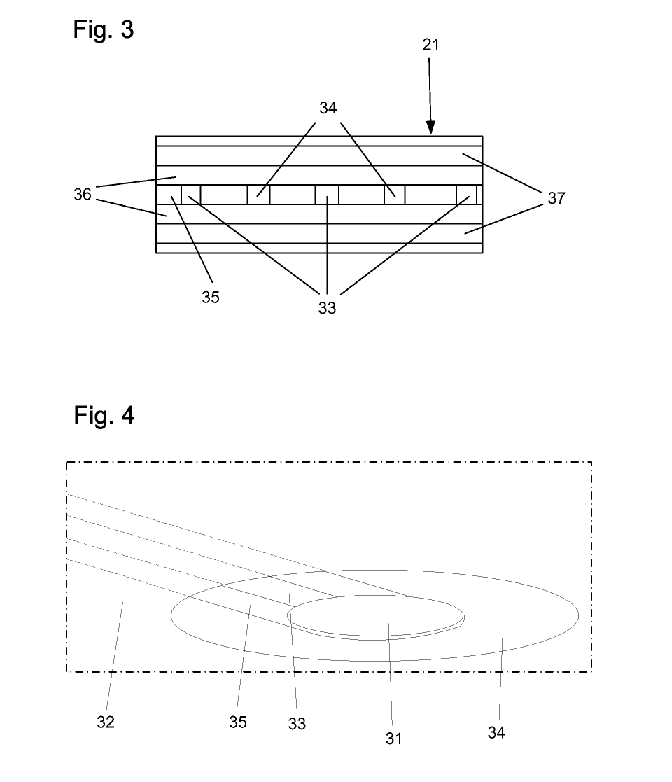

According to one embodiment of the present invention, a component of the lithographic apparatus is connected to a power supply by a flexible planar electrical connector 21. FIG. 3 schematically depicts a layered view of a planar electrical connector 21 according to an embodiment of the invention. Planar connector 21 may be electrically connected to other electrical connectors or electronic devices. In particular, planar connector 21 may be connected to a high voltage power supply.

Flexible planar electrical connector 21 includes a laminate that includes, in order, a first planar conducting layer 37, a first flexible planar insulating layer 36, a conductor 33 configured to carry an electrical current, a second flexible planar insulating layer 36, and a second planar conducting layer 37.

First and second insulating layers 36 must be sufficient to prevent electrical breakdown between conductor 33 and the conducting layers. Optionally, the insulating material of the insulating layers has a dielectric strength greater than 40 kVmm⁻¹, greater than 60 kVmm⁻¹, greater than 80 kVmm⁻¹, or greater than 100 kVmm⁻¹. The insulating material may be selected from a group consisting of a polyimide, a liquid crystal polymer and a glass. Optionally, the first insulating layer and the second insulating layer are made of poly(4,4′-oxydiphenylene-pyromellitimide).

In an embodiment, the insulating layers are thin in order to improve the flexibility of planar electrical connector 21. Optionally, a thickness of the insulating layers is less than 0.3 mm, less than 0.2 mm, less than 0.15 mm, less than 0.1 mm, or less than 0.05 mm.

Conducting layers 37 may be made of copper. As illustrated in FIG. 4, second conducting layer 37 may include a signal portion 31 that is electrically connected to conductor 33 of the planar connector and a shield portion 32 that surrounds and is electrically isolated from signal portion 31. In this case, signal portion 31 of the second conducting layer can be electrically connected to a power supply, a component of a lithographic apparatus, or another electrical connector, for example, to form an electrical connection.

FIG. 4 schematically depicts a surface of flexible electrical connector 21 from the side of the second conducting layer. The dotted lines represent the continuation of divisions between conducting and insulating regions of the layer in which conductor 33 is formed beneath the second conducting layer. Signal portion 31 and shield portion 32 of the second conducting layer are shown. In the conductor layer, conductor 33 is separated from conducting shielding within that layer by insulating material 35. Conductor 33 may be made of copper.

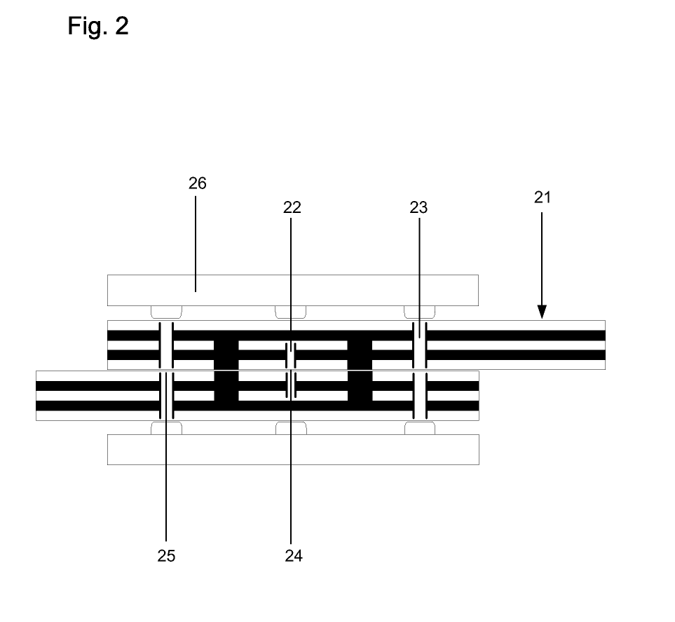

Planar electrical connector 21 may be formed as a printed circuit board (PCB). Optionally, conductor 33 of planar connector 21 is electrically connected to signal portion 31 of the second conducting layer by a via 22, as illustrated in FIG. 2. In this case, via 22 may be used to connect the planar connector to a wire, for example, by inserting the wire into via 22. Another via 23 may connect shield portion 32 of the second conducting layer to the first conducting layer.

When planar connector 21 is constructed by means of a PCB, the PCB has three or more conductive layers. The outside layers are the first and second conducting layers 37 connected to the ground potential of the application in which connector 21 is used. The inner layer is used for forming conductor 33. The layers are separated by means of insulating material 36 with sufficient dielectric strength to isolate from each other the conducting surfaces that have voltage differences between them.

The stability of the dielectric properties of the insulating material, such as the dielectric strength and its signal damping quality is relatively unimportant. Furthermore, the precise shape of conductor 33 and layers 36, 37 is relatively unimportant. This is because none of the requirements for the transmission of electromagnetic waves are applicable.

For many lithographic applications, the required voltage for the function of certain sub-systems is very high, e.g., hundreds or thousands of volts. Unless the electric field is controlled, suppressed or blocked, there is a danger that arcing occurs from conductor 33 to another component of the lithographic apparatus.

The purpose of conducting layers 37 is to electrically shield conductor 33. This prevents unwanted charge on the outside surfaces of insulators 36 of planar connector 21. Conducting layers 37 may be connected directly to insulating layers 36 with no gas-filled gap between the layers.

Conducting layers 37 confine the electric field to the interior of the connector. This is the same principle as in a coaxial cable. However, in embodiments of the present invention, the conducting layers only approximate a complete shield around conductor 33. Insulating material 36 prevents electrical breakdown via paths that are not completely shielded by a conducting shield. Optionally one or more of conducting layers 37 are connected to electrical ground.

In electrical connectors that are used to connect electrical lines, in addition to the danger of arcing between one of the electrical lines and another electrical component of the lithographic apparatus, there is the further danger of arcing between one electrical line and another piece of conductive material within the connection system. In order to electrically isolate a terminal of conductor 33 from conducting shield layers 37, an appropriate clearance must be made. The clearance must be appropriate for the voltage of conductor 33.

In an embodiment of the invention, shield portion 32 is isolated from signal portion 31 by an insulator 34. Optionally, a minimum distance between conductor 33 and conducting layers 37 is at least 0.5 mm, at least 1 mm, at least 1.5 mm, or at least 2 mm. The lower limit for distances between conducting surfaces within the planar electrical connector prevents voltage breakdown due to surface flash or exceeding of the dielectric strength of insulator layers 36.

Conventionally, only a lower limit for gap distances would be set in order to avoid electrical breakdown. However, in electrical connector 21 according to an embodiment of the present invention, an upper limit may be set for the distance between a terminal of conductor 33 and a grounded conducting surface of planar electrical connector 21. An upper limit may be necessary at the terminal of conductor 33 particularly in the case that there is no solid insulating material separating the conductor 33 from the conducting layers 37.

The upper limit for distances between the conductor terminal and other conducting surfaces of planar connector 21 reduces or avoids electrical breakdown when electrical connector 21 is used in a low-pressure environment. According to an embodiment of the invention, a minimum distance between signal portion 31 and shield portion 32 is optionally at most 3 mm, or at most 2 mm.

Setting an upper limit for gap distances at extremely low pressure prevents electrical breakdown because the relationship between breakdown voltage and gap distance is different at low pressure compared to atmospheric pressure. Specifically, at atmospheric pressure, as the gap distance is reduced, the breakdown voltage is reduced accordingly. When the pressure is sufficiently low however, the breakdown voltage dramatically increases as the gap distance is decreased below a threshold distance. The graphical form of the relationship between gap distance and breakdown voltage at a pressure of 10 Pa is depicted in FIG. 8.

Under pressure conditions that are sufficiently low, electrical breakdown is more likely to occur along a longer gap between electrical conductors than a short path. This means that provided that the distance between electrical conductors within an electrical connector is sufficiently small and the pressure is sufficiently low, the breakdown voltage will be too high for electrical breakdown to occur.

In fact, the theoretical breakdown voltage is related to the product of gap distance and pressure by the formula:

$$V = \frac{Apd}{ln ( pd ) + B} .$$

The values of the constants A and B depend on the composition of the gas, in which the conductors are situated, and the material and geometry of the conductors. For parallel plates in air, A≈450 VPa⁻¹ m⁻¹ and B≈1.5, where V is measured in Volts, p is measured in Pascals and d is measured in metres. As mentioned above, although this formula may be used to predict the theoretical electrical breakdown voltage between conductors, the actual electrical breakdown voltage in a given situation may be different from the value determined by this formula.

The minimum value of V occurs at

$$d = \frac{{e}^{1 - B}}{p} .$$

To the right of this turning point in the curve (the “elbow”), breakdown voltage is seen to behave in a well-known manner, increasing together with both increasing gap distance and pressure. To the left of the elbow, the breakdown voltage dramatically increases as either the gap distance or pressure is lowered. Therefore, electrical discharge can be reduced or avoided by ensuring that the product pd is left of the elbow.

FIG. 2 schematically depicts an electrical connection between two planar electrical connectors 21 according to an embodiment of the invention. Conductor 33 is connected to a signal portion 31 of the second conducting layer (FIG. 4). Signal portions 31 of planar connectors 21 are pressed to each other to make contact at a point 24. Additionally, shield portions 32 of planar connectors 21 make contact with each other at a point 25. Pressure plates 26 may be used to provide the pressure to connect planar connectors 21. The pressure plates may be made of metal.

Planar connector 21 according to an embodiment of the invention is suitable for use in a lithographic apparatus. Optionally, the lithographic apparatus according to an embodiment of the invention includes a controller CN (FIG. 1) for controlling a display means to displaying a signal that the situation is safe when the pressure is below a threshold value, for example 10 Pa. A pressure sensor detects the pressure within the vacuum vessel. When the pressure sensor detects that the pressure has increased above the threshold value, controller CN stops the signal from being displayed. Optionally, controller CN prevents the pressure inside the vacuum vessel from increasing above a predetermined value, for example 20 Pa, when there is an unintended leak.

Optionally, the lithographic apparatus includes a safety cut out system. Controller CN sends a signal to switch off the power supply when the pressure increases above a particular pressure. For example, a pressure sensor detects the pressure. When it is detected that the pressure is greater than 20 Pa, for example, controller CN sends a switch-off signal to the power supply unit.

The invention is not limited to having a single conductor 33 formed from an inner layer of flexible planar electrical connector 21. Flexible connector 21 may include a plurality of conductors 33 between the first insulating layer and the second insulating layer (FIG. 3). In this case, conductors 33 may be separated from each other by conducting shielding 34. For example, conductors 33 may be formed from a single layer of copper, with conductors 33 and intermediate shielding portions 34 formed by an etching operation. Insulating material 35 electrically isolates intermediate shielding portions 34 from conductors 33. In one embodiment, the number of conductors 33 in the electrical connector is three. However, the number may be two, four, five, six, nine etc.

As described above, two flexible planar electrical connectors 21 may be connected to each other by pressing conductor portions 31 against each other to provide an electrical interconnect. The pressing of the two surfaces against each other provides the electrical connection. This principle of pressing is based on the Paschen law according to which electrical breakdown may be avoided by reducing the distance between conducting surfaces in a low-pressure (i.e., vacuum) environment. The electrical field produced by the conductor 33 depends on the shape of the conductor 33, the distance between conductors (in the case that there are multiple conductors), the thickness of the layers of insulting material 36 and the dielectric constant of the isolating material.

The conductor 33 in the inner layer of the planar connector 21 may take the form of a trace. The conductor 33 may be disposed in the inner layer of the planar connector 21 parallel to the shield portion 32 of the planar connector 21, the shield portion 32 being in an outer layer of the planar connector 21. When the planar connector 21 is connected to a high voltage power supply, there is a high potential difference between the conductor 33 and the shield portion 32. The shield portion 32 is adjacent to an insulating layer 36 and also adjacent to the gas of the environment in which the planar connector 21 is situated. There is a point, which may be termed a “triple point”, at which the shield portion 32 (which is formed from an electrically conductive material), the insulating material of the insulating layer 36 and the ambient gas each come into contact with each other. At this triple point, the electric field at the edge of the conducting material of the shield portion 32 may be amplified. The level of amplification depends on the difference between the dielectric constant of the insulating material of the insulating layer 36 and the dielectric constant of the ambient gas. This amplification results in enhanced field emission. The field emission may result in unwanted electrical breakdown.

As an example, the dielectric constant of polyimide, which may be used as the insulating material of the insulating layer 36, is approximately 3.4. The dielectric constant for the ambient gas may be about 1.0. This would result in an amplification of the electric field of approximately 3.4 times.

The increased electric field strength may result in a degradation of the insulating material of the insulating layer 36 and/or the conducting material of the shield portion 32. This may result in a decrease in the lifetime of the material that is affected.

The shield portion 32 may itself be connected to ground potential. As mentioned above, the high voltage conductor 33 may be directed parallel to the shield portion 32. The large potential difference between the conductor 33 and the shield portion 32 may result in an electric field at the triple point of the shield portion 32. The planar connector 21 may have multiple triple points.

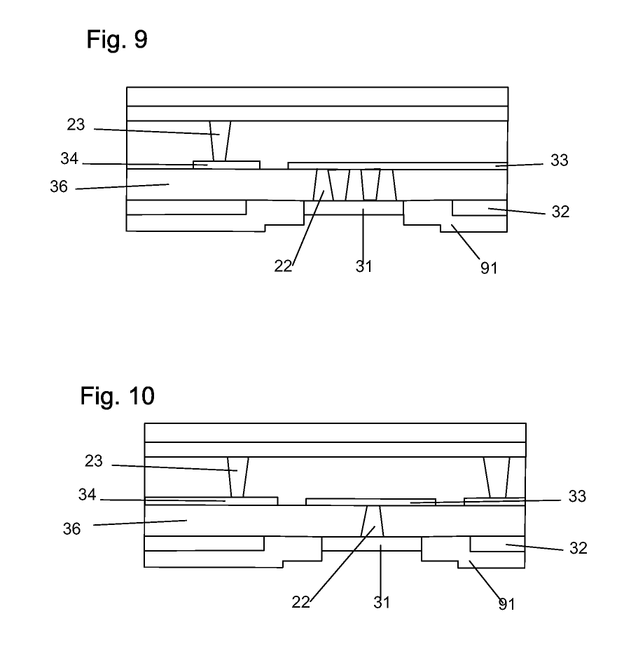

FIG. 9 depicts a cross-sectional view of a planar connector 21 according to an embodiment of the invention. The longitudinal direction of the conductor 33 is in the plane of the cross-section. In the embodiment depicted in FIG. 9, a triple point insulator 91 covers the shield portion 32 of the planar connector 21. Desirably, the triple point insulator 91 is disposed in the region between the shield portion 32 and the conductor portion 31 of the planar connector 21. The triple point insulator may substantially surround the conductor portion 31. The triple point insulator 91 isolates the triple point from the ambient gas. The triple point insulator 91 isolates parts of the shield portion that come into contact with the insulating layer 36 from the ambient gas. Desirably the triple point insulator prevents an entirety of shield portion 32 from coming into contact with the ambient gas.

This effectively eliminates any triple point from the planar connector 21. This prevents any amplification of the electrical field at such a triple point, thereby reducing the likelihood of electrical breakdown. In an embodiment, a thickness of the planar connector 21 at a portion having the triple point insulator 91 is greater than a thickness of the planar connector 21 at a portion without the triple point insulator 91 (e.g., at the conductor portion 31).

The electrical fields of the conductor portion 31 and the conductor 33 vary in accordance with the shapes of the conductor 33 and conductor portion 31 and the distances between them.

FIG. 10 depicts a cross-sectional view of a planar connector 21 according to an embodiment of the invention. The longitudinal direction of the conductor is perpendicular to the plane of the cross-section. The shapes and sizes of the conductor portion 31 and the conductor 33 are chosen so as to reduce the possibility of electrical breakdown from the electrical fields of the conductor 33 and the conductor portion 31.

The diameter of the conductor portion 31 is less than the width (not the thickness) of the conductor 33. Desirably, the difference between the width of the conductor 33 and the width of the conductor portion 31 is at least 2.5×H, where H is the distance between the inner layer and the outer layer of the planar connector 21. H is the thickness of the insulating layer 36.

Desirably, the width of the conductor 33 is between 2 mm and 4 mm, more desirably between 2.5 mm and 3.5 mm, or more desirably approximately 3 mm. Desirably, the distance between the conductor 33 and the insulator 34 (of the inner layer of the planar connector 21) is between 0.5 mm and 1.5 mm, and more desirably approximately 1 mm. A distance between the conductor portion 31 and the shield portion 32 of the outer layer of the planar connector 21 is desirably between 1 mm and 3 mm, or more desirably between 1.5 mm and 2.5 mm, or more desirably approximately 2 mm. The diameter of the conductor portion 31 may be between 1.5 mm and 3.5 mm, or more desirably between 2 mm and 3 mm, or more desirably approximately 2.5 mm.

The arrangement of shapes and relative distances of the conductor 33 and the conductor portion 31 of the planar connector 21 depicted in FIG. 10 results in a planar connector 21 having an increased lifetime and reduced possibility of electrical breakdown.

In an embodiment, the conductor portion 31 is not on the same level as the outermost covering layer at the contact side of the planar connector 21. For example, as depicted in FIG. 9, the conductor portion 31 may be at a depression of the outer surface of the planar connector 21 with respect to the triple point insulator 91. It is possible that a bad connection will result when two planar connectors 21 are pressed against each other to form an electrical connection between the respective conductor portions 31. In order to improve the contact, the connection between the two planar connectors 21 may be adapted as described below.

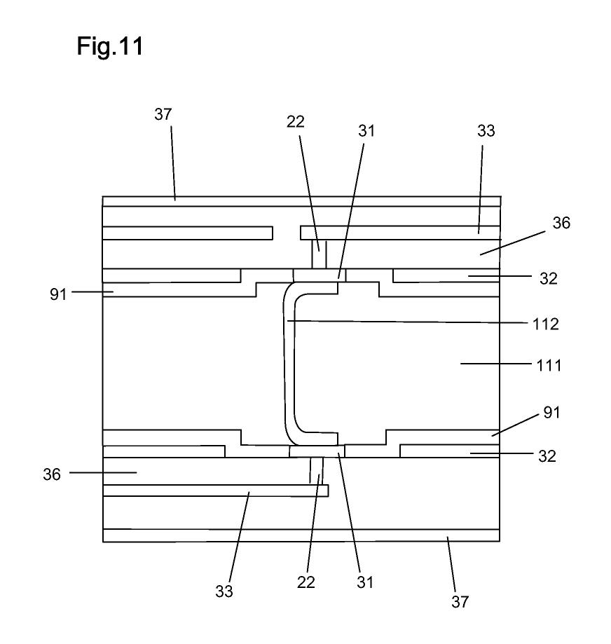

FIG. 11 depicts an embodiment of the invention in which two planar connectors 21 are connected to each other to faun an electrical connection. FIG. 11 is schematic and may not represent the aspect ratio of the manufactured embodiment of the invention. As depicted in FIG. 11, there may be an insulating sheet 111 positioned between the two planar connectors 21 that are to form the electrical connection. The two planar connectors 21 may be electrically connected indirectly, through the insulating sheet 111. Electrical connection may be formed between the respective conducting portions 31 via a contact 112 formed of a conductive material that penetrates through the insulating sheet 111. The contact 112 may be integrated with the insulating sheet 111. The electrical connection may be made via the contact 112.

The insulating sheet 111 may be made of a fluoropolymer elastomer. Other materials may also be used, provided that the material has an electrically insulating quality. As an example, the insulating sheet 111 may be formed of Viton®. The insulating sheet 111 may be formed of a thickness between 0.5 mm and 1.5 mm, or more desirably approximately 1 mm.

The contact 112 may take the form of a leaf spring, also known as a semi-elliptical spring. The leaf spring that forms the contact 112 is formed of an electrically conductive material. The leaf spring may be made of stainless steel, for example. Other electrically conducting materials may also be used. Desirably a thickness of the contact 112 is between 20 μm and 40 μm, and more desirably approximately 30 μm.

The leaf spring that is the contact 112 makes electrical contact with the conductor portion 31 of the planar connector 21 at an end of the contact 112. Desirably, an end of the contact 112 is dimensionally smaller than the conductor portion 31 of the planar connector 21. This arrangement improves the tolerance of the electrical connection. As an example, a diameter of the end of the contact 112 may be between 1 mm and 3 mm, or more desirably approximately 2 mm, compared to the diameter of the conductor portion 31 of the planar connector 21, which may be approximately 3 mm. By using a leaf spring as the contact 112, the elastic restoration force of the leaf spring presses the ends of the contact 112 against the conductor portions 31 of the planar connectors 21, thereby providing a secure electrical connection. The leaf spring is in an elastically compressed state when the connection is made.

The embodiment depicted in FIG. 11 may have a triple point insulator 91 that covers the shield portion 32 of the planar connector 21. The triple point insulator 91 may have the same characteristics as described in relation to FIG. 9 above.

The above described embodiments of electrical connectors and electrical connection systems 21 of the present invention are suitable for use in a lithographic apparatus to connect an actuator of either a mask table MT or a substrate table WT to a power supply 20. Additionally, embodiments of the present invention may be used to connect the actuator or controller of any beam interceptor 210 (such as a blade) or the electrodes of any electrostatic clamp that may form part of a lithographic apparatus. However, the electrical connector and electrical connection system according to embodiments of the present invention is not limited to use as part of a lithographic apparatus. The electrical connector and electrical connection system is applicable in other situations where it is desired to connect electrical lines that carry high voltages in low pressure environments.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

Although specific reference may have been made above to the use of embodiments of the invention in the context of optical lithography, it will be appreciated that the invention may be used in other applications, for example imprint lithography, and where the context allows, is not limited to optical lithography. In imprint lithography, topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

The terms “radiation” and “beam” used herein encompass all types of electromagnetic radiation, including ultraviolet (UV) radiation (e.g., having a wavelength of or about 365, 355, 248, 193, 157 or 126 nm) and extreme ultra-violet (EUV) radiation (e.g., having a wavelength in the range of 5-20 nm), as well as particle beams, such as ion beams or electron beams.

The term “lens”, where the context allows, may refer to any one or combination of various types of optical components, including refractive, reflective, magnetic, electromagnetic and electrostatic optical components.

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g., semiconductor memory, magnetic or optical disk) having such a computer program stored therein.

The descriptions above are intended to be illustrative, not limiting. Thus, it will be apparent to one skilled in the art that modifications may be made to the invention as described without departing from the scope of the claims set out below.

What is claimed is:

1. A lithographic apparatus arranged to transfer a pattern onto a substrate comprising:
a power supply; and
an electrical connector comprising a laminate that comprises, in order, the following layers:
a first conducting layer;
a first flexible insulating layer;
a conductor configured to carry an electrical current;
a second flexible insulating layer; and
a second conducting layer;
wherein the electrical connector electrically connects the power supply to another component of the lithographic apparatus.

2. The lithographic apparatus according to claim 1, wherein the second conducting layer comprises:
a conductor portion electrically connected to the conductor; and
a shield portion that surrounds and is electrically isolated from the conductor portion.

3. The lithographic apparatus according to claim 2, wherein a minimum thickness of the first insulating layer, t1, a minimum thickness of the second insulating layer, t2, a dielectric strength of the first insulating layer, s1, and a dielectric strength of the second insulating layer, s2, are set such that t1×s1≧10 kV and t2×s2≧10 kV .

4. The lithographic apparatus according to claim 2, wherein a minimum distance, d, between the conductor portion and the shield portion is set such that 0.5 mm≦d≦3 mm, and preferably 0.5 mm≦1.5 mm.

5. The lithographic apparatus according to claim 3, wherein a minimum distance, d, between the conductor portion and the shield portion is set such that, and preferably 0.5 mm<1.5 mm.

6. The lithographic apparatus according to claim 1, wherein the lithographic apparatus further comprises:
a vacuum chamber; and
a vacuum evacuator configured to reduce the pressure within the vacuum chamber to less than the pressure of the environment in which the evacuator is located;
wherein the electrical connector and the component of the lithographic apparatus to which the electrical connector connects the power supply are inside the vacuum chamber;
wherein optionally the pressure within the vacuum chamber is less than or equal to 100 Pa.

7. The lithographic apparatus according to claim 2, wherein there is a plurality of conductors between the first insulating layer and the second insulating layer and a corresponding plurality of conductor portions in the second conducting layer each electrically connected to a corresponding conductor, wherein the shield portion surrounds and is electrically isolated from each of the conductor portions.

8. The lithographic apparatus according to claim 2, wherein the conductor is electrically connected to the conductor portion of the second conducting layer by a via.

9. The lithographic apparatus according to claim 1, wherein the conductor is electrically connected to a second electrical connector comprising a laminate that comprises, in order, the following layers;
a first conducting layer;
a first flexible insulating layer;
a conductor configured to carry an electrical current;
a second flexible insulating layer;
a second conducting layer.

10. The lithographic apparatus according to claim 9, wherein the second conducting layer of both electrical connectors comprises:
a conductor portion electrically connected to the conductor; and
a shield portion that surrounds and is electrically isolated from the conductor portion;
wherein the conductor portions of the electrical connectors are electrically connected to each other and optionally the shield portions of the electrical connectors are electrically connected to each other.

11. The lithographic apparatus according to claim 2, wherein the electrical connector further comprises a triple point insulator that covers the shield portion, and optionally surrounds the conductor portion.

12. The lithographic apparatus according to claim 2, wherein a width of the conductor portion is less than a width of the conductor, optionally by at least 2.5×H, where H is the thickness of the second flexible insulting layer.

13. The lithographic apparatus according to claim 9, wherein an insulating sheet is disposed between the electrical connectors, wherein the electrical connection is indirect via a contact that penetrates the insulating sheet.

14. The lithographic apparatus according to claim 13, wherein the contact is a semi-elliptical spring, wherein optionally an end of the semi-elliptical spring is dimensionally smaller than the conductor portion.

15. The lithographic apparatus according to claim 1, wherein a thickness of the first flexible insulating layer and/or the second flexible insulating layer is in the range of from about 50 μm to about 150 μm, and/or a thickness of the conductor is in the range of from about 15 μm to about 25 μm, and/or a thickness of the semi-elliptical spring is in the range of from about 20 μm to about 40 μm, and/or a thickness of the insulating sheet is in the range of from about 0.5 mm to about 1.5 mm.

16. The lithographic apparatus according to claim 1, wherein the lithographic apparatus further comprises:
a substrate table for holding a substrate;
an electrostatic chuck for holding said substrate to said substrate table, said electrostatic chuck comprising a planar member made of a dielectric material and being a separate body to said substrate table; and
first and second clamp electrodes, said first clamp electrode being provided on said substrate table and said second clamp electrode being provided as a conductive layer on said substrate;
wherein the other component to which the electrical connector electrically connects the power supply is one of the first electrode and the second electrode;
wherein optionally the electrical connector is held to the electrode by a clip and optionally a pin that is connected to the clip and extends through a hole in the electrical connector to contact the substrate or substrate table on which the electrode is formed.
